(19) United States
(12) Patent Application Publication
(10) Pub. No.: US 2007/0063386 A1
(43) Pub. Date: Mar. 22, 2007

(54) Mold tool having movable core

(76) Inventor: Richard T. Seaver, Montague, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/515,138

(22) Filed: Sep. 1, 2006

Related U.S. Application Data
(60) Provisional application No. 60/713,461, filed on Sep. 1, 2005.
(60) Provisional application No. 60/713,662, filed on Sep. 2, 2005.

(51) Int. Cl. B29C 45/26; B29C 33/44

(52) U.S. Cl. 264/328.7; 425/577; 425/468

(57) ABSTRACT

A mold tool includes one or more movable core members that push against molten material in the mold cavity during the packing stage of the molding process and thereby reduce the amount of time required for the packing stage of the molding process. The movable core member may be movably mounted in a cavity in a mold half, with nitrogen springs biasing the movable core member to generate a force on the molten material in the mold cavity.

### CROSS-REFERENCE TO RELATED APPLICATIONS

The present application claims the benefit of U.S. Provisional Application No. 60/713,461, filed on Sep. 1, 2005, and also claims the benefit of U.S. Provisional Application No. 60/713,662, filed on Sep. 2, 2005. The entire contents of each of these applications are hereby incorporated by reference.

### BACKGROUND OF THE INVENTION

Injection molding has been widely used to fabricate various parts. In general, the molten polymer material is injected into the cavity through one or more nozzle bars. After the cavity is completely filled with molten polymer material, pressure may be maintained on the polymer material in the cavity by pressuring the molten material in the nozzle bars. This stage of the molding process is commonly referred to as “packing”. Packing of the molten polymer material during cooling of the polymer material in the mold cavity alleviates shrinkage, voids and other such defects that would otherwise occur during the solidification of the molten polymer material in the mold cavity.

Depending upon the geometry, size, polymer material being molded, and other such variables, the packing stage of the molding process may require a significant amount of time. Thus, although packing alleviates problems associated with shrinking of the polymer material during the solidification process, the packing portion of the process may contribute substantially to the cycle time and cost required to mold a particular part.

Heretofore, attempts to reduce the packing time in a practical manner have met with little or no success. Accordingly, a way to reduce the packing time while maintaining the proper shape and other material properties of a molded part would be advantageous.

### SUMMARY OF THE INVENTION

A mold tool according to one aspect of the present invention includes one or more movable core members that push against molten material in the mold cavity during the packing stage of the molding process and thereby reduce the amount of time required for the packing stage of the molding process. The movable core member may be movably mounted in a cavity in a mold half, with nitrogen springs biasing the movable core member to generate a force on the molten material in the mold cavity.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a partially schematic elevational view of an injection molding machine including a mold having a movable core according to one aspect of the present invention;

FIG. 2 is a partially schematic cross-sectional view of the mold with movable core of FIG. 1;

FIG. 3 is an exploded perspective view of the movable core and mold part;

FIG. 4 is a partially schematic, cross-sectional view of a mold having a plurality of movable core members according to another aspect of the present invention; and

FIG. 5 is a partially schematic cross-sectional view of a mold having a movable mold cavity according to another aspect of the present invention.

### DETAILED DESCRIPTION OF PREFERRED EMBODIMENT

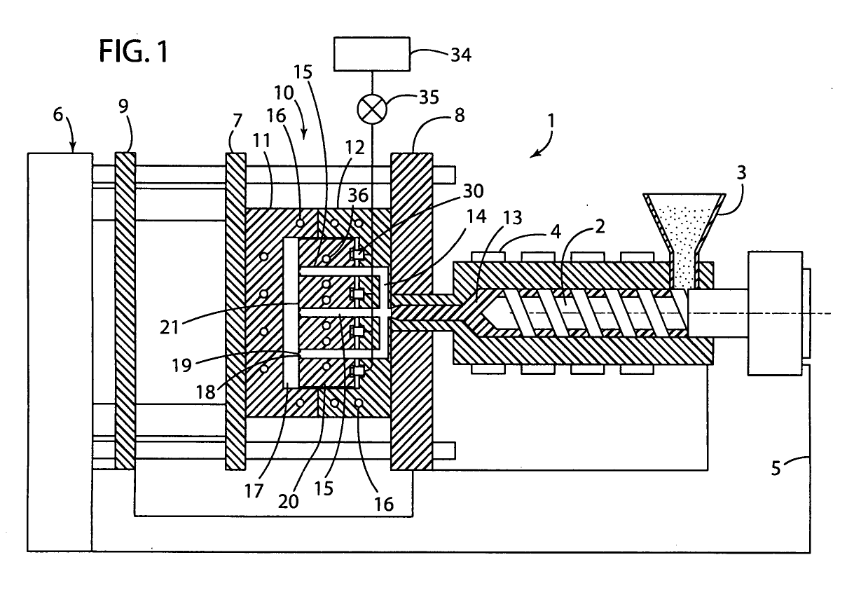

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

An injection molding machine 1 includes a conventional reciprocating screw/hydraulic drive 2, a hopper 3, and heater bands 4 that are supported by a base 5. A clamping mechanism 6 is operably connected to a movable platen 7. A forward platen 8 and rear platen 9 are stationary. A mold 10 according to one aspect of the present invention includes a first half 11 that is secured to the movable platen 7, and a second half 12 that is secured to the stationary platen 8. A plurality of cooling passages 16 in mold halves 11 and 12 provide for cooling.

As discussed in more detail below, during an operation molten plastic material 13 is injected into mold cavity 17 through a conventional manifold 14 and one or more conventional nozzle bars 15 that are secured to second half 12 of mold 10. Ends 18 of nozzle bars 15 extend through openings 19 in mold surface 21 of a movable core member 20 to inject the molten plastic material 13 into mold cavity 17. After the parts are formed, movable platen 7 is shifted toward rear platen 9, and conventional ejector pins (not shown) contact rear platen 9 to eject the parts from the mold 10.

Movable core member 20 is movably mounted to mold half 12, and nitrogen springs 30 resiliently biases movable core member 20 towards mold half 11. Pressure from molten plastic material 13 in mold cavity 17 on mold surface 21 of movable core member 20 causes movable core member 20 to shift towards mold half 12. The force generated by nitrogen springs 19 causes movable core member 20 to maintain pressure on the molten plastic material 13 in mold cavity 17 over substantially the entire mold surface 21 of movable core member 20, and thereby pack the molten plastic material in mold cavity 17. In this way, movable core member 20 provides pressure over a large portion of the surface of the part being molded, and greatly increases the effectiveness of the packing stage of the molding process.

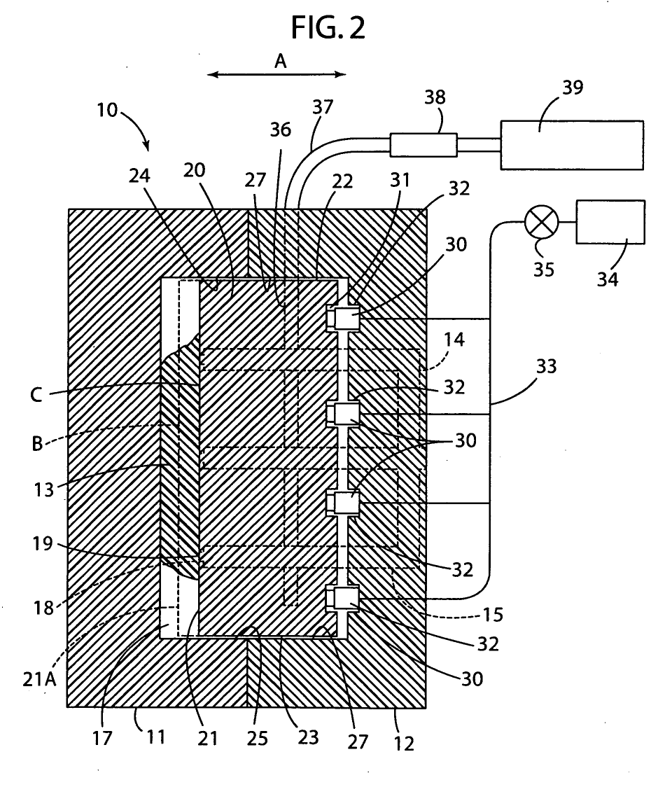

With further reference to FIG. 2, in the illustrated example movable core 20 includes a mold surface 21 forming a side wall of mold cavity 17. The movable mold core 20 also includes side surfaces 22 and 23 that fit closely against side walls 24 and 25 of mold half 11, and side walls 26 and 27 of mold half 12. It will be understood that, in addition to side walls 22-27, movable core member 20 fits closely against the inner side walls of mold halves 11 and 12 around the entire perimeter of movable core member 20. Also, it will be readily understood that the clearance between the movable core member 20 and mold half 11 and/or mold half 12 is preferably sufficiently small to prevent flow of molten plastic between the movable core member 20 and mold halves 11 and/or 12 to thereby prevent formation of flash.

One or more resilient biasing members such as nitrogen springs 30 provide for back and forth movement of movable core member in the direction of the arrow “A” (FIG. 2). In the illustrated example, the nitrogen springs 30 are mounted in cylindrical pockets 31 in movable core member 20, and cylindrical pockets 32 in mold half 12. A conduit or line 33 operably connects the nitrogen springs 30 to a source of pressurized nitrogen 34. A regulator 35 permits adjustment of the pressure in the nitrogen springs 30 to thereby adjust the amount of force required to move the movable core member 20. One or more cooling passages 36 extend through the movable core member 20, and conventional flexible coolant lines 37 are connected to a manifold 38 and coolant source 39 to thereby distribute liquid coolant through the cooling passages 36. Lines 37 are flexible and thereby permit movement of the movable core member 20 relative to the mold half 12.

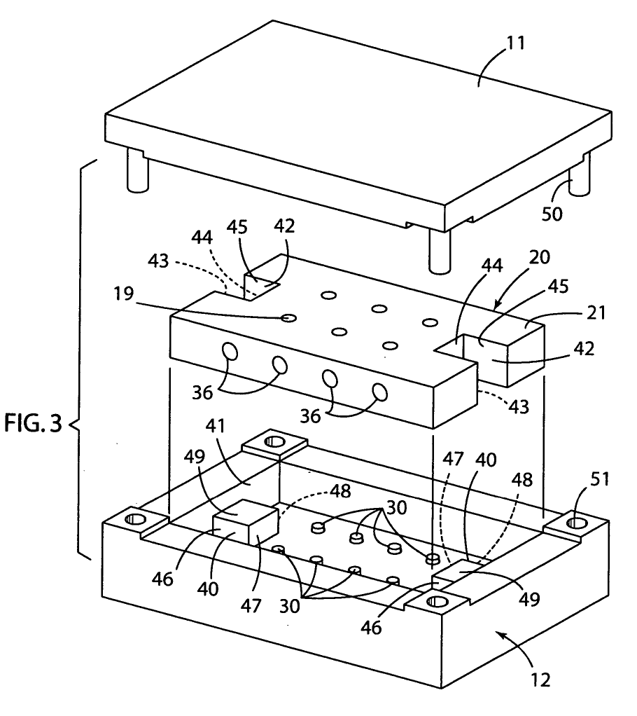

With further reference to FIG. 3, the first mold half 11 may be guided and/or positioned relative to second mold half 12 by conventional pins 50 and bushings 51. Also, conventional die locks (not shown) may also be utilized to position the mold halves 11 and 12 relative to one another when in the closed position. Movable core member 20 is slidably interconnected with mold half 12 by a guide structure such as guide blocks 40 mounted in cavity 41 of mold half 12 and notches 42 of movable core member 20. The side surfaces 43, 44 and 45 of notches 20 closely yet slidably engage the corresponding side surfaces 46, 47 and 48, respectively of guide blocks 40. In the illustrated example, the top surfaces 49 of guide blocks 40 form a portion of the side wall of the mold cavity 17. Alternately, notch 42 may be configured so it does not extend vertically completely through movable core member 20, and mold surface 21 of core member 20 extends uninterrupted over notch 42 to form a continuous mold surface. It will be understood that a variety of guides, pins, bushings and the like may be utilized to movably guide and interconnect the movable core member 20 with second mold half 12.

With reference back to FIG. 2, during operation the mold cavity 17 is initially empty, and the movable core 20 is in an extended position “B” with mold face 21 in the position designated “21A”. The movable core member 20 is biased to the extended position B due to the force generated by the nitrogen springs 30. After the mold halves 11 and 12 are closed, molten plastic material 13 is injected into the cavity 17 through nozzle bars 15 and openings 19 in mold surface 21 of movable core member 20. As the mold cavity 17 fills with the molten plastic material 13, force is generated on the mold surface 21 of movable core member 20 due to the pressurized molten plastic 13. This pressure causes the movable core member 20 to shift to a retracted position “C”, compressing nitrogen springs 30. The molten plastic material 13 is then allowed to cool and solidify during the packing portion of the molding process. During the packing portion of the process, the nitrogen springs 30 generate substantial force on the molten plastic 13 over a wide area of the part being molded, thereby providing a substantially improved packing of the part. Due to the improved packing, the time required for packing can be substantially reduced. For example, in one part made by a mold 10 according to one aspect of the present invention, the packing time was reduced from around 12 seconds to around 1 second. It will be readily apparent to those skilled in the art that a reduction in packing time of this magnitude represents a substantial improvement relative to prior arrangements.

In the illustrated example, the nitrogen springs 30 are pressurized to provide about 500 lbs. of force for each spring. A total of 8 nitrogen springs 30 are utilized, thereby providing a total of 4,000 lbs. of force. Although this arrangement has proved satisfactory, the amount of force generated by nitrogen springs 30 could be increased or decreased by adjustment of regulator 35 to optimize the packing process as required for a particular part to be molded. In the illustrated example, the nitrogen springs 30 are capable of about 0.50 inch of travel, and the movable core member 20 is configured to move about 0.17 inch when shifting from the extended position B to the retracted position C. It will be understood that more or less movement of core member 20 may be utilized if required for a particular application. Also, it will be understood that conventional coil springs or the like could be utilized instead of nitrogen springs 30. Furthermore, other mechanical or electromechanical devices or actuators could also be utilized to provide for movement of movable core member 20 and for generation of force for packing. Furthermore, it will also be understood that the mold surface 21 of movable core member 20 may include a variety of shapes and features as required to mold a particular part.

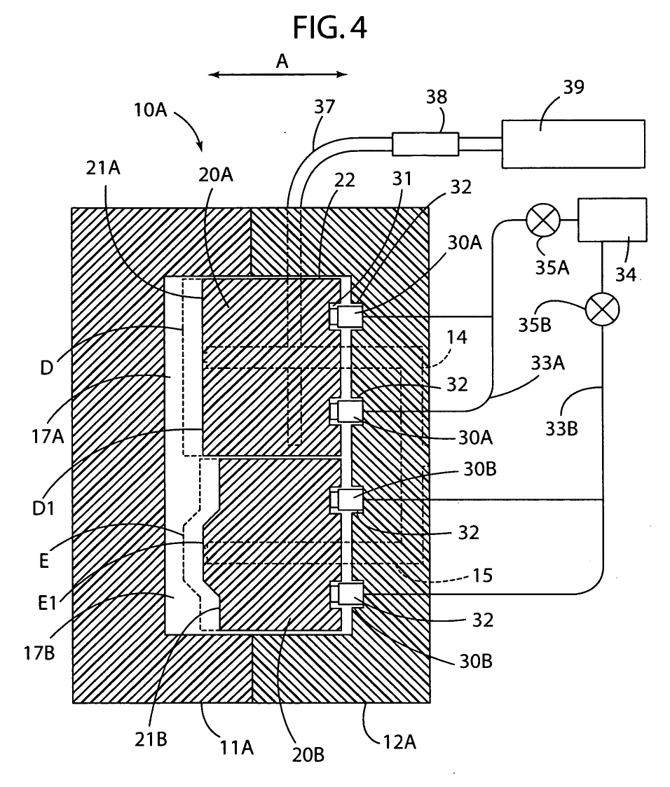

With further reference to FIG. 4, a mold 10A according to another aspect of the present invention includes a first movable core member 20A and a second movable core member 20B. Nitrogen springs 30A are connected to a nitrogen source 34 and a pressure regulator or the like 35A that provides for adjustment of the force generated by the nitrogen springs 30A. Second movable core member 20B is biased to the extended position E by nitrogen springs 30B that are connected to a nitrogen source 34 by lines 33B. Regulator 35B can be used to adjust the force of nitrogen springs 30B. Because the movable core members 20A and 20B are individually controlled with respect to the force generated by the nitrogen springs, the movable mold core parts 20A and 20B may provide different packing forces in different areas of the part/mold cavity that may be required due to differences in the shape and/or size of the mold surfaces 21A and 21B. During operation of mold 10A, molten plastic is injected through nozzle bars 15 into a first cavity portion 17A and a second cavity portion 17B, thereby shifting the movable core members 20A and 20B to the retracted positions D1 and E1, respectively.

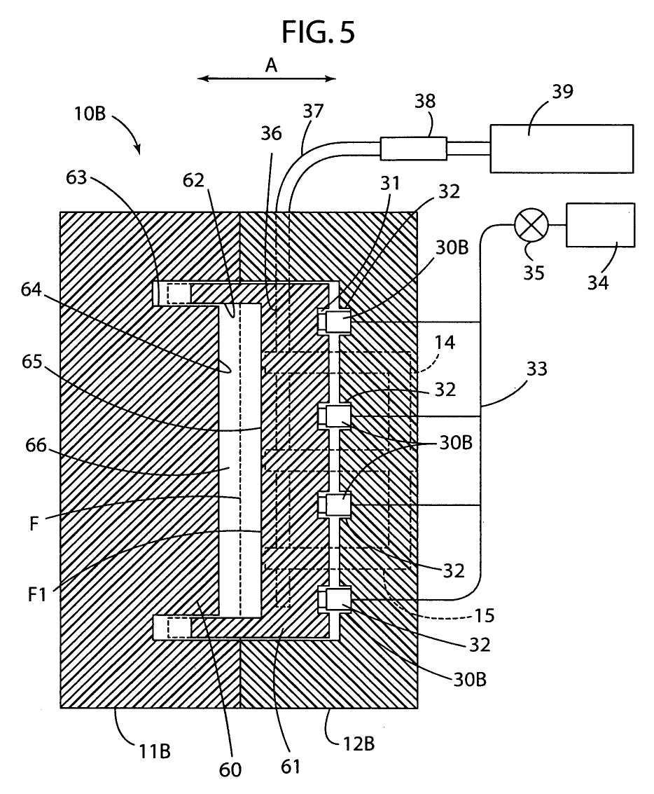

With further reference to FIG. 5, a mold 10B according to another aspect of the present invention includes a stationary core 60 and a movable cavity member 61. Movable cavity member 61 includes side surfaces 62 that fit closely adjacent to side walls 63 of stationary core 60. Mold surface 64 of stationary core 60 and mold surface 65 of movable cavity member 61 define a mold cavity 66. During operation, molten plastic material is injected into the mold cavity 66, thereby shifting the movable cavity member 61 from the extended position F to the retracted position F1 and compressing nitrogen springs 30B.

The mold 10 with movable core member(s) or movable cavity of the present application provide substantially improved packing of parts during the molding process. The reduced packing time substantially reduces the cycle time for the molding process and thereby lowers the cost required to mold the parts. Furthermore, the movable core member(s) or movable cavity member provide substantially even pressure on the part in the mold cavity during the packing process, thereby reducing warp and other distortion. The improved packing provided by the movable core(s)/cavity also permit molding of thinner parts than would be possible using conventional molds and processes.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A mold tool, comprising:
first and second mold members movable relative to one another to define open and closed states of the mold tool, the first mold member having a first mold cavity surface generally facing the second mold member, the first mold cavity surface defining a first mold cavity portion, the first mold member having a side face surface extending around the first mold cavity surface, the second mold member defining a core-receiving cavity generally facing the first mold member;
a core member movably disposed in the core-receiving cavity of the second mold member, the core member having a second mold cavity surface generally facing the first mold cavity portion and defining therewith a mold cavity when the mold tool is in the closed state;
at least one resilient member biasing the core member towards the mold cavity surface of the first mold member.

2. The mold tool of claim 1, wherein:
the first and second mold members are movably interconnected by a linear guide defining an axis of movement along which the first and second mold members move relative to one another;
the core-receiving cavity defines a base surface and sidewall surfaces that are parallel to the axis of movement.

3. The mold tool of claim 2, wherein:
the core member has side surfaces closely fitting against the sidewall surfaces of the core-receiving cavity.

4. The mold tool of claim 2, wherein:
the core member includes die surfaces extending around the core member to define a core perimeter;
the first mold cavity surface includes a base portion and sidewall portions, the sidewall portions extending parallel to the side surfaces of the core member.

5. The mold tool of claim 4, wherein:
the sidewall portions of the first mold cavity surface fit closely against the side surfaces of the core member to form a seal that substantially prevents flow of molten plastic between the core member and the first mold member.

6. The mold tool of claim 1, wherein:
the at least one resilient member comprises a plurality of gas springs.

7. The mold tool of claim 6, wherein:
the gas springs have an internal chamber with pressurized gas therein operably coupled to a source of pressurized gas whereby the pressure of the gas in the internal chambers can be adjusted to adjust a force generated by the gas springs.

8. The mold tool of claim 1, including:
at least one nozzle member mounted to the second mold member and extending through the core member, the nozzle member having an exit port in fluid communication with the mold cavity.

9. The mold tool of claim 8, wherein:
the at least one nozzle member comprises a plurality of substantially similar nozzle members; and including:
a plurality of passageways fluidly coupled to the nozzle members and supplying the nozzle members with molten plastic during operation of the mold tool.

10. An injection molding machine, comprising:
a base structure;
a powered drive and heating apparatus configured to provide molten plastic material to a mold;
a first platen interconnected to the base structure; and wherein at least one of the first and second platens comprises a movable platen that moves between a retracted position and a closed position;
a second platen interconnected to the base structure;
a clamp mechanism configured to hold the movable platen in the closed position;
a first mold member secured to the first platen and defining a first mold cavity surface;
a second mold member secured to the second platen;
a movable core member movably connected to the second mold member and having a second mold cavity surface;
wherein the first and second mold cavity surfaces define a mold cavity having a variable volume when the first platen is in the closed position; and wherein:
the movable core member is movable relative to the second mold member between a retracted position and an extended position and vary a volume of the mold cavity and defining a mold cavity shaped to form a finished part when in the extended position.

11. The injection molding machine of claim 10, wherein:
the movable core member is biased towards the extended position.

12. The injection molding machine of claim 11, wherein:
the powered drive and heating apparatus injects molten plastic material into the mold cavity under sufficient pressure to move the movable core member from the extended position towards the retracted position.

13. The injection molding machine of claim 12, including:
at least one gas spring biasing the movable core member towards the extended position.

14. The injection molding machine of claim 12, including:
a plurality of gas springs biasing the movable core member towards the extended position;
a source of pressurized gas operably coupled to the gas springs and supplying the gas springs with pressurized gas; and
a regulator controlling the pressure of the gas supplied to the gas springs.

15. The injection molding machine of claim 10, wherein:
the second mold member includes a core-receiving cavity defining sidewall surfaces; and
the movable core member defines outwardly facing surfaces and is closely received in the core-receiving cavity with the outwardly facing surfaces forming a seal that substantially prevents flow of molten plastic between the sidewall surfaces and the outwardly facing surfaces.

16. The injection molding machine of claim 10, wherein:
the movable core member includes a movable cavity facing the first mold member; and
the first mold member includes a protrusion received in the movable cavity.

17. The injection molding machine of claim 16, wherein:
the movable cavity defines sidewall surfaces and a base wall surface;
the protrusion includes an end surface and outer perimeter surfaces fitting closely against the sidewall surfaces and forming a seal that substantially prevents flow of molten plastic material between the perimeter surfaces and the sidewall surfaces.

18. A method of molding parts, comprising:
providing a mold having a mold cavity and a movable core member defining a movable mold surface exposed to the mold cavity;
injecting molten material into the mold cavity such that some of the molten material contacts the movable mold surface and moves the movable core member.

19. The method of claim 18, wherein:
the movable core member is movable between extended and retracted positions; and including:
biasing the movable core member into the extended position.

20. The method of claim 17, wherein:
the molten material comprises a molten polymer material;
the molten polymer material solidifies during a packing stage of the method;
the movable core member pressurizes the molten polymer material during the packing stage.

21. The method of claim 20, wherein:
the packing stage lasts for about one second.

22. A mold tool, comprising:
first and second mold parts movable relative to one another to define open and closed states of the mold tool;
the first mold part having a first mold cavity surface generally facing the second mold part, the first mold cavity surface defining a first mold cavity portion;
the second mold part defining a core support structure;
a core movably engaging the core support structure of the second mold member, the core having a second mold cavity surface generally facing the first mold cavity portion and defining therewith a mold cavity when the mold tool is in the closed state;
at least one resilient member biasing the core towards the mold cavity surface of the first mold part.

23. The mold tool of claim 22, wherein:
the first and second mold parts are movably interconnected by a linear guide defining an axis of movement along which the first and second mold parts move relative to one another;
the core support structure comprises a core-receiving cavity having a base surface and sidewall surfaces that are parallel to the axis of movement.

24. The mold tool of claim 23, wherein:
the core has side surfaces closely fitting against the sidewall surfaces of the core-receiving cavity.

25. The mold tool of claim 22, wherein:
the resilient member comprises a plurality of nitrogen springs.

26. The mold tool of claim 22, wherein:
the first and second mold parts define peripheral mold sealing surfaces that contact each other when the mold tool is in the closed state to prevent escape of molten material from the mold cavity.
